(19) United States
(12) Patent Application Publication
(10) Pub. No.: US 2012/0097520 A1
(43) Pub. Date: Apr. 26, 2012

(54) PROCESS AND APPARATUS FOR SEPARATION OF HYDROCARBONS AND NITROGEN

(75) Inventors: Grant Leigh Johnson, Lymm (GB); Adrian Joseph Finn, Sowerby Bridge (GB); Terence Ronald Tomlinson, Stockport (GB)

(73) Assignee: COSTAIN OIL, GAS & PROCESS LIMITED, Manchester (GB)

(21) Appl. No.: 13/259,371

(22) PCT Filed: Mar. 23, 2010
(86) PCT No.: PCT/GB10/50486

§ 371 Date: Dec. 6, 2011

(30) Foreign Application Priority Data
Mar. 25, 2009 (GB) 0905125.1

(51) Int. Cl. B01D 3/14

(52) U.S. Cl. 203/23; 203/24; 203/91; 203/39; 202/159

(57) ABSTRACT

The invention provides a process and apparatus for the separation of a gaseous feed comprising a mixture of hydrocarbons and nitrogen gas, the process comprising the steps of: (i) cooling and at least partially condensing the gaseous feed; (ii) feeding the cooled and at least partially condensed feed from step (i) to a fractionation column comprising reboil to produce an overhead hydrocarbon vapour stream enriched in nitrogen and a condensed hydrocarbon product stream low in nitrogen, wherein prior to the fractionation, the feed stream is divided into at least two streams including: a) a first stream which is expanded and fed to the fractionation column; b) a second stream which is expanded, heated and fed to a lower stage of the fractionation column than the first stream, (iii) removing a hydrocarbon product stream low in nitrogen from the fractionation column; and (iv) removing a hydrocarbon vapour stream enriched in nitrogen from the fractionation column.

This invention relates to processes and apparatus for the low temperature separation of nitrogen from a gaseous mixture comprising nitrogen gas and hydrocarbons. Such mixtures occur naturally in geological formations and can also result from nitrogen injection as a method of improving oil or gas production. Nitrogen separation may be required as part of an overall processing of gaseous hydrocarbons to meet sales specifications, such as maximum inert content or minimum calorific value.

Low temperature fractionation presents an energy efficient method for separation of nitrogen from gaseous hydrocarbon streams, in particular gaseous hydrocarbon streams wherein the hydrocarbons comprise predominantly methane, such as natural gas. Separated nitrogen streams of high purity can be produced, thereby maximising hydrocarbon recovery and, where the nitrogen stream is vented to atmosphere, minimising environmental impact.

Where the nitrogen content is higher than approximately 35 to 40 mol %, single and double column systems, similar to those used in air separation, are conventional and are often the most economical choice considering both capital cost and energy consumption. In a double column system, the columns are typically configured in a stacked arrangement, with the upper fractionation column operating at low pressure, just above atmospheric, and the lower fractionation column operating at high pressure, typically at approximately 27 bar.

Where nitrogen content is lower than approximately 35 mol %, for example 5 to 25 mol %, however, insufficient reflux is generated in a conventional double column system to maintain both high hydrocarbon recovery and low nitrogen content in the hydrocarbon product. In the case of single column systems, increased power is required to provide the necessary condenser duty.

In such cases, options to increase the available reflux include:
a) compressing the reject nitrogen stream and recycling it to the feed gas or other part of the process to meet reflux requirements; and
b) introducing an upstream ‘pre-separation’ system to condition the feed gas to produce a stream suitably enriched in nitrogen to feed a downstream separation system.

The choice of which of these procedures to use can depend on a variety of factors, including plant capacity, feed gas nitrogen content and variability, feed and product gas pressure. The use of an upstream ‘pre-separation’ system is efficient in producing product gas at elevated pressure, hence reducing product gas compression power requirements and may also be preferred when the gaseous feed comprises contaminants such as carbon dioxide and heavy hydrocarbons, which are tolerated at higher levels in the ‘pre-separation’ system.

The present invention provides a process and apparatus for the separation of a gaseous mixture comprising nitrogen gas and hydrocarbons to produce a hydrocarbon product stream low in nitrogen, and a hydrocarbon vapour stream enriched in nitrogen and suitable for further downstream separation by conventional fractionation processes and apparatus. This provides additional flexibility to process gases having low nitrogen content, for example less than 35 mol %, and potentially as low as 5 to 25 mol %. In addition, the process and apparatus of the invention uses improved heat integration to minimise power requirements, particularly where the feed gas is at significantly higher pressure than the fractionation column in the pre-separation system.

In a first aspect, the present invention provides a process for the separation of a gaseous feed comprising a mixture of hydrocarbons and nitrogen gas, the process comprising the steps of:
(i) cooling and at least partially condensing the gaseous feed;
(ii) feeding the cooled and at least partially condensed feed from step (i) to a fractionation column comprising reboil to produce an overhead hydrocarbon vapour stream enriched in nitrogen and a condensed hydrocarbon product stream low in nitrogen, wherein prior to the fractionation, the feed stream is divided into at least two streams including:
   a) a first stream which is expanded and fed to the fractionation column;
   b) a second stream which is expanded, heated and fed to a lower stage of the fractionation column than the first stream,
(iii) removing a hydrocarbon product stream low in nitrogen from the fractionation column; and
(iv) removing a hydrocarbon vapour stream enriched in nitrogen from the fractionation column,
and wherein the fractionation column is devoid of an overhead reflux condenser.

Due to its increased nitrogen content, the hydrocarbon vapour stream removed from the fractionation in step (iv) is particularly suitable for downstream separation processes that require the nitrogen content of the feed gas to be higher than approximately 35 to 40 mol %, as described above. Thus, the hydrocarbon vapour stream enriched in nitrogen may be subjected to downstream separation to produce a hydrocarbon product stream low in nitrogen, and a nitrogen rich stream low in hydrocarbons. In comparison with a standard fractionation column having a single feed and bottom reboiler, the use of multiple feeds according to the present invention potentially allows the fractionation column diameter to be reduced.

Fractionation columns in pre-separation systems are usually configured with an overhead reflux condenser, particularly where the nitrogen content is low or if there is a need to prevent carbon dioxide and heavy hydrocarbon contaminants from passing into the overhead vapour stream from the fractionation column. There is, however, a disadvantage in the use of an overhead reflux condenser due to the power requirements to cool the condenser.

in known processes, the hydrocarbon product low in nitrogen from the fractionation is often used to provide refrigeration to both the overhead reflux condenser and to the feed gas. However, the hydrocarbon product low in nitrogen from the fractionation must be evaporated at a lower temperature and pressure to provide adequate refrigeration to the reflux condenser than is required to provide adequate refrigeration to the feed gas, thus increasing the energetically costly requirement for recompression of the hydrocarbon product. In the process of the present invention, the use of first and second feed streams provides for the recovery of a greater proportion of hydrocarbon product in step (ii), and for the recovery of a hydrocarbon vapour stream in step (iii) having a higher nitrogen content than is obtained with known processes, even without the use of an overhead reflux condenser. More specifically, the first feed stream acts as a thermally efficient source of reflux for the fractionation column. Accordingly, the present invention avoids an overhead condenser apparatus and the compression power requirements associated with the use of a hydrocarbon product low in nitrogen from the fractionation to provide refrigeration to the reflux condenser.

The operating pressure for the fractionation column will typically be in the range of from 2.5 MPa to 4.0 MPa, and the gaseous feed is supplied at a pressure above, and preferably significantly above, the operating pressure of the fractionation column. Accordingly, the gaseous feed may be supplied at a pressure of at least 0.2 MPa above, more preferably at least 0.5 MPa above, and most preferably at least 1.0 MPa above the operating pressure of the fractionation column.

In a preferred embodiment, the feed stream is divided into at least three streams prior to the fractionation, and a third stream is expanded and fed to a stage of the fractionation intermediate the first and second streams.

The ratio of individual feeds to the column is dependent on the feed stream composition and pressure, as would be well understood by a person skilled in the art. However, an example of suitable ranges, where the process comprises three feed streams, include 15 to 35% of the feed gas composition passed into the column via the top feed stream, 40 to 60% via the mid feed stream, and 15 to 35% via the bottom feed stream.

The gaseous feed preferably comprises methane, for example, the gaseous feed may comprise or consist of natural gas. In further preferred embodiments, the gaseous feed comprises less than 35 mol % nitrogen, still more preferably between 5 and 25 mol % nitrogen. The gaseous feed may further comprise other inert gases, such as helium.

If required, the gaseous feed may be subjected to one or more pre-treatment procedures to remove impurities and/or unwanted components which could solidify in the fractionation.

The gaseous feed is partially condensed prior to the fractionation. Advantageously heat exchange during cooling of the gaseous feed may be used to provide reboil to the fractionation. In one preferred embodiment, the hydrocarbon product stream low in nitrogen from the fractionation is pumped to elevated pressure and evaporated to provide cooling to the gaseous feed. In another embodiment, the hydrocarbon product stream low in nitrogen obtained from the fractionation is divided into at least two streams, and one of the streams is expanded to provide additional cooling for the gaseous feed. However, an advantage of the present invention is that a significant proportion of the refrigeration of the feed gas can be obtained by Joule Thomson expansion of the feed gas. Accordingly, the need to expand a portion of the hydrocarbon product stream is minimised and may be avoided altogether, thus minimising the energy required for recompression of the hydrocarbon product stream.

Alternatively, or in addition, further improvements in the thermal efficiency of the process may be achieved through cooling of the gaseous feed by heat exchange with at least a portion of the hydrocarbon product low in nitrogen from the downstream separation and/or at least a portion of the nitrogen rich stream low in hydrocarbons from the downstream separation.

In step (ii), the first stream is preferably sub-cooled prior to being fed to the fractionation, and cooling may be obtained by heat exchange with at least a portion of the hydrocarbon product low in nitrogen from the downstream separation and/or at least a portion of the nitrogen rich stream low in hydrocarbons from the downstream separation, thereby minimising power consumption.

In step (ii), the second stream is preferably heated, after expansion, and prior to being fed to the fractionator via heat exchange with the feed gas.

It will be appreciated by the skilled person that the residual nitrogen content of the hydrocarbon product low in nitrogen obtained from the fractionation, and the nitrogen content of the hydrocarbon vapour stream enriched in nitrogen removed from the fractionation are dependent on the composition of the feed gas. However, the hydrocarbon product low in nitrogen obtained from the fractionation may comprise less than 5 mol % nitrogen gas, less than 2 mol % nitrogen gas, and less than 1 mol % nitrogen gas. The hydrocarbon vapour stream enriched in nitrogen removed from the fractionation preferably comprises from 30 to 60 mol % nitrogen gas, and more preferably comprises from 40 to 60 mol % nitrogen gas.

Where the hydrocarbon vapour stream enriched in nitrogen removed from the fractionation is subjected to downstream separation, the hydrocarbon vapour stream enriched in nitrogen is cooled prior to the downstream separation. In one embodiment, energy efficient cooling is obtained by heat exchange with at least a portion of the hydrocarbon product stream low in nitrogen obtained from the downstream separation and/or at least a portion of the nitrogen rich stream low in hydrocarbons obtained from the downstream separation.

The downstream separation may be effected according to any suitable procedure known in the art for the separation of nitrogen from a gaseous mixture comprising nitrogen and hydrocarbons. Suitable procedures include low temperature single column processes or low temperature double column processes. For instance, a suitable low temperature single column process may comprise one or more condensers and an open or closed heat pump circuit providing refrigeration. A suitable low temperature double column process may comprise final separation in a column operating at near atmospheric pressure, and a high pressure column producing methane enriched and nitrogen enriched streams which are fed to the low pressure column.

In a second aspect, the present invention provides an apparatus for the separation of a gaseous feed comprising a mixture of hydrocarbons and nitrogen gas, the apparatus comprising:
(i) means for cooling and at least partially condensing the gaseous feed;
(ii) a fractionation column for producing an overhead vapour stream and a condensed product;
(iii) means for dividing the feed stream into at least two streams upstream of the fractionation column, including means for:
   a) expanding a first stream upstream of the fractionation column and conveying it to the fractionation column;
   b) means for expanding and heating a second stream upstream of the fractionation column and conveying it to a lower stage of the fractionation column than the first stream,
(iv) means for conveying a hydrocarbon product low in nitrogen from the fractionation column; and
(v) means for conveying a hydrocarbon vapour stream enriched in nitrogen from the fractionation column.

Preferably, the apparatus comprises means for dividing the feed stream into at least three streams, including means for expanding a third stream and conveying it to a stage of the fractionation column intermediate the first and second streams.

In a preferred embodiment, the fractionation column comprises a reboil heat exchanger, which enables reboil in the fractionation column to be provided in an energy efficient way during cooling of the gaseous feed. The reboil heat exchanger may be submerged in liquid in the sump of the fractionation column, or alternatively boiling liquid at the bottom of the fractionation column may be piped to the reboil heat exchanger from a bottom tray or packed section of the fractionation column. Preferably, the fractionation column is devoid of an energetically costly overhead reflux condenser.

Preferably, the apparatus comprises means for cooling the first stream. Heating of the second stream and/or cooling of the first stream is advantageously provided by means of heat exchangers, thereby reducing the power consumption of the system. Preferably, multistream heat exchangers which combine a number of heat exchange duties into a single heat exchange unit are used. For example, the heat exchange may be a multistream plate-fin type heat exchanger, such as a multistream brazed aluminium plate-fin type heat exchanger.

Suitable means for expanding at the first and second streams, more preferably the at least three streams, include expansion valves and liquid or two-phase expansion turbines. Advantageously, the use of liquid or two-phase expansion turbines allows energy to be recovered from the system, further improving the efficiency of the separation.

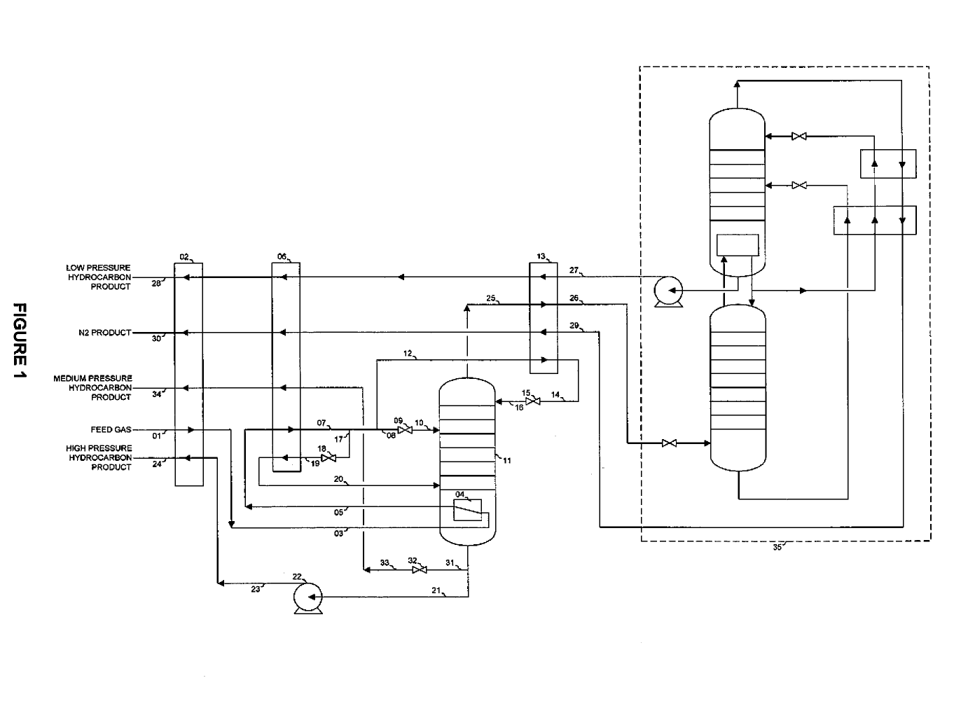

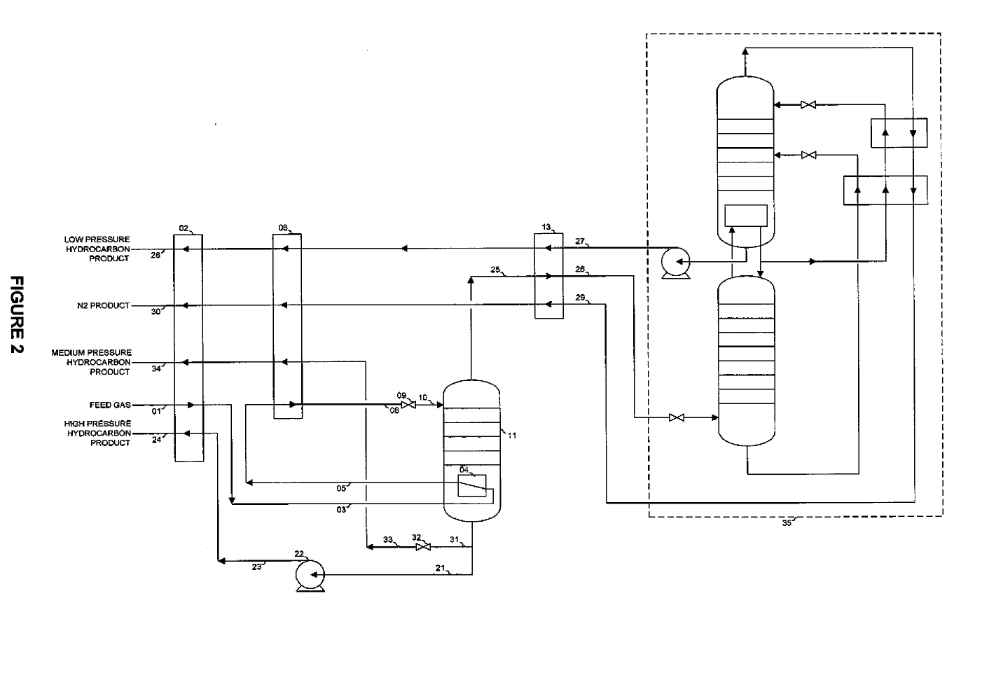

The invention will now be described in greater detail with reference to a preferred embodiment of the invention and with the aid of the accompanying FIG. 1; and the accompanying FIG. 2 which discloses a conventional process.

FIG. 1 shows a separation apparatus in accordance with the invention. The apparatus comprises a fractionation column (11) comprising a reboil heat exchanger (04). Boiling liquid at the bottom of the fractionation column (11) may either be piped to the reboil heat exchanger (04) from a bottom tray or packed section of the fractionation column (11), or the reboil heat exchanger may be submerged in the boiling liquid in the sump of the fractionation column (11). Means for heating and cooling the various product and feed streams is provided by heat exchangers (02), (06) and (13), and the apparatus is shown coupled to a standard downstream separation apparatus (35).

A gaseous feed stream comprising a mixture of hydrocarbons and nitrogen gas (01) is cooled, sub-cooled and at least partially condensed in heat exchangers (02), (04) and (06). The resulting stream (07) is split into three streams:
a) a first stream (12), which is further sub-cooled in heat exchanger (13) and expanded across an expander (15) to form a reflux liquid feed stream (16) which is fed to an upper stage of the fractionation column (11);
b) a second stream (17), which is expanded across an expander (18) and reheated in heat exchanger (06) to form a heated and expanded feed stream (20) which is fed to a lower stage of the fractionation column than the reflux liquid feed (16); and
c) a third stream (08), which is expanded across an expander (09) to form a feed stream (10) which is fed to the fractionation column at a stage intermediate the reflux liquid feed (16) and heated and expanded feed stream (20).

A hydrocarbon product stream low in nitrogen is recovered from the bottom of the fractionation column (11), and at least a portion of said stream, and more preferably all of said stream, forms a stream (21) which is pumped to elevated pressure by a pump (22). The resulting stream (23) is evaporated and reheated in heat exchanger (02) to form a high pressure gaseous product (24). Evaporation and reheating of the hydrocarbon stream (23) in heat exchanger (02) preferably provides at least a portion of, and more preferably the majority of, the refrigeration required for cooling and condensation of the gaseous feed stream (01).

If necessary, depending on the composition and pressure of the feed gas (01), a portion of the hydrocarbon product stream low in nitrogen recovered from the bottom of the fractionation column (11) forms a stream (31), which is expanded across an expander (32) to form a medium pressure stream (33). The medium pressure stream is evaporated and reheated in heat exchanger (02) to provide additional cooling to the gaseous feed stream (01).

The overhead stream (25) from the fractionation column comprises a hydrocarbon vapour stream enriched with nitrogen (11). The stream is cooled and preferably at least partially condensed in heat exchanger (13) to form a gaseous feed stream (26) which is fed to a standard downstream separation apparatus (35). In FIG. 1, a standard double column separation apparatus (35) is shown. However, as noted above, a number of different known separation processes may be used in place of the standard double column apparatus (35) shown in FIG. 1.

A hydrocarbon product stream with low nitrogen content (27), obtained from the downstream separation (35) is evaporated in heat exchanger (13), to provide further cooling to the overhead stream (25), and reheated in heat exchangers (13), (06) and the gaseous feed streams (01) and (05). Further cooling of the overhead stream (25) and the gaseous feed streams (01) and (05) is obtained by the reheating of a nitrogen stream with low hydrocarbon content (29) obtained from the downstream separation (35).

### EXAMPLES

### Present Invention

Table 1 shows typical operating parameters for the apparatus of this invention, shown in FIG. 1, when used to separate a gaseous mixture consisting of 17 mol % nitrogen gas and 83 mol % hydrocarbons. A feed pressure of 8.0 MPa is considered in this example. In addition, 26% by molar flow of the feed gas composition is passed into the column via the top feed stream, 52% via the mid feed stream, and 22% via the bottom feed stream.

In the process of this invention shown in FIG. 1, refrigeration for feed gas cooling is provided by reboiler (04), by evaporating and rewarming hydrocarbon product streams to produce low pressure (28) and high pressure (24) products, by reheating nitrogen gas (30), and self refrigeration by reheating part of the feed gas (19). In this example there is no requirement to evaporate and rewarm hydrocarbon product at medium pressure (34).

TABLE 1

| Stream¹ | | 01 | 03 | 05 | 08 | 10 | 12 |
|---|---|---|---|---|---|---|---|
| Pressure² | MPa | 8.00 | 7.94 | 7.92 | 7.90 | 3.23 | 7.90 |
| Temperature | ° C. | 45.0 | −79.4 | −95.1 | −110.0 | −112.1 | −110.0 |
| Mass Flow | kg/h | 92493 | 92493 | 92493 | 48096 | 48096 | 24048 |
| Molar Flow | kgmol/h | 5000.0 | 5000.0 | 5000.0 | 2600.0 | 2600.0 | 1300.0 |
| Nitrogen | mol % | 17.0 | 17.0 | 17.0 | 17.0 | 17.0 | 17.0 |
| Methane | mol % | 80.5 | 80.5 | 80.5 | 80.5 | 80.5 | 80.5 |
| Ethane | mol % | 2.0 | 2.0 | 2.0 | 2.0 | 2.0 | 2.0 |
| Propane | mol % | 0.5 | 0.5 | 0.5 | 0.5 | 0.5 | 0.5 |
| Stream¹ | | 14 | 16 | 17 | 19 | 20 | 21 |
| Pressure² | MPa | 7.88 | 3.23 | 7.90 | 3.05 | 3.03 | 7.06 |
| Temperature | ° C. | −125.0 | −125.2 | −110.0 | −112.7 | −100.4 | −88.8 |
| Mass Flow | kg/h | 24048 | 24048 | 20349 | 20349 | 20349 | 50530 |
| Molar Flow | kgmol/h | 1300.0 | 1300.0 | 1100.0 | 1100.0 | 1100.0 | 2987.0 |
| Nitrogen | mol % | 17.0 | 17.0 | 17.0 | 17.0 | 17.0 | 1.5 |
| Methane | mol % | 80.5 | 80.5 | 80.5 | 80.5 | 80.5 | 94.4 |
| Ethane | mol % | 2.0 | 2.0 | 2.0 | 2.0 | 2.0 | 3.3 |
| Propane | mol % | 0.5 | 0.5 | 0.5 | 0.5 | 0.5 | 0.8 |
| Stream¹ | | 24 | 25 | 26 | 27 | 28 | 29 |
| Pressure² | MPa | 7.00 | 3.00 | 2.97 | 0.94 | 0.85 | 0.20 |
| Temperature | ° C. | 41.2 | −112.0 | −132.2 | −152.0 | 41.2 | −161.4 |
| Mass Flow | kg/h | 50530 | 41963 | 41963 | 19789 | 19789 | 22174 |
| Molar Flow | kgmol/h | 2987.0 | 2013.0 | 2013.0 | 1218.0 | 1218.0 | 795.0 |
| Nitrogen | mol % | 1.5 | 40.0 | 40.0 | 1.5 | 1.5 | 99.0 |
| Methane | mol % | 94.4 | 59.9 | 59.9 | 98.3 | 98.3 | 1.0 |
| Ethane | mol % | 3.3 | 0.1 | 0.1 | 0.2 | 0.2 | 0.0 |
| Propane | mol % | 0.8 | 0.0 | 0.0 | 0.0 | 0.0 | 0.0 |

| Stream¹ | | 30 | 31 | 33 | 34 |
|---|---|---|---|---|---|
| Pressure² | MPa | 0.15 | — | — | — |
| Temperature | ° C. | 41.2 | — | — | — |
| Mass Flow | kg/h | 22174 | No Flow | No Flow | No Flow |
| Molar Flow | kgmol/h | 795.0 | No Flow | No Flow | No Flow |
| Nitrogen | mol % | 99.0 | — | — | — |
| Methane | mol % | 1.0 | — | — | — |
| Ethane | mol % | 0.0 | — | — | — |
| Propane | mol % | 0.0 | — | — | — |

¹As identified in FIG. 1
²Pressures are given as absolute values

### Comparative Example

Table 2 shows typical operating parameters for conventional apparatus incorporating a fractionation column with reboiler and single column feed, shown in FIG. 2, when used to separate the same gaseous mixture.

Overhead vapour (25) from the fractionation column (11) is enriched in nitrogen to 40 mol % and is processed further in a nitrogen rejection system producing a low pressure hydrocarbon product stream (27) with a residual nitrogen content of 1.5 mol % and a nitrogen product stream (29) with a residual hydrocarbon content of 1.0 mol %. Bottom liquid (21, 31) from the fractionation column has residual nitrogen content of 1.5 mol %.

In the conventional process shown in FIG. 2, refrigeration for feed gas cooling is provided by reboiler (04), by evaporating and rewarming hydrocarbon product streams to produce low pressure (28), medium pressure (34) and high pressure (24) products, and by reheating nitrogen gas (30).

TABLE 2

| Stream¹ | | 01 | 03 | 05 | 08 | 10 | 21 |
|---|---|---|---|---|---|---|---|
| Pressure² | MPa | 8.00 | 7.94 | 7.92 | 7.90 | 3.03 | 8.06 |
| Temperature | ° C. | 45.0 | −76.6 | −95.3 | −106.7 | −111.8 | −87.3 |
| Mass Flow | kg/h | 92493 | 92493 | 92493 | 92493 | 92493 | 43755 |
| Molar Flow | kgmol/h | 5000.0 | 5000.0 | 5000.0 | 5000.0 | 5000.0 | 2587.0 |
| Nitrogen | mol % | 17.0 | 17.0 | 17.0 | 17.0 | 17.0 | 1.5 |
| Methane | mol % | 80.5 | 80.5 | 80.5 | 80.5 | 80.5 | 94.4 |
| Ethane | mol % | 2.0 | 2.0 | 2.0 | 2.0 | 2.0 | 3.3 |
| Propane | mol % | 0.5 | 0.5 | 0.5 | 0.5 | 0.5 | 0.8 |
| Stream¹ | | 24 | 25 | 26 | 27 | 28 | 29 |
| Pressure² | MPa | 8.00 | 3.00 | 2.97 | 0.94 | 0.85 | 0.20 |
| Temperature | ° C. | 42.0 | −111.8 | −132.2 | −152.0 | 42.0 | −161.4 |
| Mass Flow | kg/h | 43755 | 41973 | 41973 | 19799 | 19799 | 22174 |
| Molar Flow | kgmol/h | 2587.0 | 2013.0 | 2013.0 | 1218.0 | 1218.0 | 795.0 |
| Nitrogen | mol % | 1.5 | 40.0 | 40,0 | 1.5 | 1.5 | 99.0 |
| Methane | mol % | 94.4 | 59.9 | 59.9 | 98.3 | 98.3 | 1.0 |
| Ethane | mol % | 3.3 | 0.1 | 0.1 | 0.2 | 0.2 | 0.0 |
| Propane | mol % | 0.8 | 0.0 | 0.0 | 0.0 | 0.0 | 0.0 |

| Stream¹ | | 30 | 31 | 33 | 34 |
|---|---|---|---|---|---|
| Pressure² | MPa | 0.15 | 3.03 | 2.30 | 2.23 |
| Temperature | ° C. | 42.0 | −95.7 | −103.4 | 42.0 |
| Mass Flow | kg/h | 22174 | 6765 | 6765 | 6765 |
| Molar Flow | kgmol/h | 795.0 | 400.0 | 400.0 | 400.0 |
| Nitrogen | mol % | 99.0 | 1.5 | 1.5 | 1.5 |
| Methane | mol % | 1.0 | 94.4 | 94.4 | 94.4 |
| Ethane | mol % | 0.0 | 3.3 | 3.3 | 3.3 |
| Propane | mol % | 0.0 | 0.8 | 0.8 | 0.8 |

¹As identified in FIG. 2
²Pressures are given as absolute values

### Results

The total compression power required to recompress products to 8.0 MPa for the conventional process of FIG. 2 is 3250 kW, calculated based on 80% polytropic efficiency for compression and accounting for inter-cooling to 45° C. Power for pump (22) is 270 kW based on 75% efficiency, making a total power requirement of 3520 kW.

Calculated on the same basis, the compression power required to compress products to 8.0 MPa for the process of this invention as shown in FIG. 1 is 3070 kW. Power for pump (22) is 250 kW based on 75% efficiency, making a total power requirement of 3320 kW, a reduction of 5.7% compared with the conventional process of FIG. 2.

1. A process for the separation of a gaseous feed comprising a mixture of hydrocarbons and nitrogen gas, the process comprising the steps of:
(i) cooling and at least partially condensing the gaseous feed;
(ii) feeding the cooled and at least partially condensed feed from step (i) to a fractionation column comprising reboil to produce an overhead hydrocarbon vapour stream enriched in nitrogen and a condensed hydrocarbon product stream low in nitrogen, wherein prior to the fractionation, the feed stream is divided into at least two streams including:
a) a first stream which is expanded and fed to the fractionation column;
b) a second stream which is expanded, heated and fed to a lower stage of the fractionation column than the first stream,
(iii) removing a hydrocarbon product stream low in nitrogen from the fractionation column; and
(iv) removing a hydrocarbon vapour stream enriched in nitrogen from the fractionation column,
and wherein the fractionation column is devoid of an overhead reflux condenser.

2. A process according to claim 1 wherein the feed stream is divided into at least three streams prior to the fractionation, including a third stream which is expanded and fed to a stage of the fractionation intermediate the first and second streams.

3. A process according to claim 1, wherein the hydrocarbon vapour stream enriched in nitrogen from step (iv) is subjected to downstream separation to produce a hydrocarbon product stream low in nitrogen, and a nitrogen rich stream low in hydrocarbons.

4. A process according to claim 1, wherein the hydrocarbons in the gaseous feed comprise or consist of methane.

5. A process according to claim 1, wherein the gaseous feed comprises or consists of natural gas.

6. A process according to claim 1, wherein the gaseous feed comprises less than 35 mol % nitrogen gas.

7. A process according to claim 1, wherein the gaseous feed comprises from 5 to 25 mol % nitrogen gas.

8. A process according to claim 1, wherein reboil in the fractionation column is provided at least in part by heat exchange during cooling and at least partial condensing of the gaseous feed.

9. A process according to claim 1, wherein at least a portion of the hydrocarbon product stream low in nitrogen obtained from the fractionation is pumped to elevated pressure and evaporated to provide cooling for the gaseous feed.

10. A process according to claim 9, wherein the hydrocarbon product stream low in nitrogen obtained from the fractionation is divided into at least two streams, and wherein one of the streams is expanded to provide additional cooling for the gaseous feed.

11. A process according to claim 9, wherein substantially all of the hydrocarbon product stream low in nitrogen obtained from the fractionation is used to provide cooling for the gaseous feed.

12. A process according to claim 3, wherein the feed is cooled via heat exchange with at least a portion of the hydrocarbon product stream low in nitrogen obtained from the downstream separation and/or at least a portion of the nitrogen rich stream low in hydrocarbons obtained from the downstream separation.

13. A process according to claim 3, wherein the first stream is sub-cooled prior to being fed to the fractionation.

14. A process according to claim 13, wherein the cooling is by heat exchange with at least a portion of the hydrocarbon product stream low in nitrogen obtained from the downstream separation and/or at least a portion of the nitrogen rich stream low in hydrocarbons obtained from the downstream separation.

15. A process according to claim 1, wherein the second stream is heated, after expansion, via heat exchange with the feed gas.

16. A process according to claim 1, wherein the fractionation column has an operating pressure of from 2.5 MPa to 4 MPa.

17. A process according to claim 1, wherein the gaseous feed is provided at a pressure of at least 0.2 MPa above the operating pressure of the fractionation column.

18. A process according to claim 1, wherein the gaseous feed additionally comprises further inert gases.

19. A process according to claim 18, wherein the further inert gases include helium.

20. A process according to claim 1, wherein the gaseous hydrocarbon feed is pre-treated to remove impurities and/or other unwanted components which solidify under process conditions.

21. A process according to claim 1, wherein the hydrocarbon product stream low in nitrogen is removed from the fractionation as a condensed product.

22. An apparatus for the separation of a gaseous feed comprising a mixture of hydrocarbons and nitrogen gas, the apparatus comprising:
(i) means for cooling and at least partially condensing the gaseous feed;
(ii) a fractionation column for producing an overhead vapour stream and a condensed product, the fractionation column comprising a reboil heat exchanger;
(iii) means for dividing the feed stream into at least two streams upstream of the fractionation column, including means for:
a) expanding a first stream upstream of the fractionation column and conveying it to the fractionation column;
b) means for expanding and heating a second stream upstream of the fractionation column and conveying it to a lower stage of the fractionation column than the first stream,
(iv) means for conveying a hydrocarbon product low in nitrogen from the fractionation column; and
(v) means for conveying a hydrocarbon vapour stream enriched in nitrogen from the fractionation column, and
wherein the fractionation column is devoid of an overhead reflux condenser.

23. An apparatus according to claim 22, wherein the apparatus comprises means for dividing the feed stream into at least three streams, including means for expanding a third stream and conveying it to a stage of the fractionation column intermediate the first and second streams.

24. (canceled)

25. An apparatus according to claim 22, further comprising means for cooling the first stream.

26. An apparatus according to claim 22, wherein heating or cooling is provided by means of heat exchangers.

27. An apparatus according to claim 22, wherein the means for expanding the streams comprises liquid or two-phase expansion turbines.

28. A process according to claim 1, wherein the first stream is sub-cooled prior to being fed to the fractionation.
